(19) United States
(12) Patent Application Publication
(10) Pub. No.: US 2005/0162125 A1
(43) Pub. Date: Jul. 28, 2005

(54) Integrated induction battery charge apparatus

(76) Inventors: Win-Chee Yu, Taipei (TW); Chien-Li Wu, Taipei (TW)

Correspondence Address: RABIN & BERDO, P.C., Suite 500, 1101 14 Street, N.W., Washington, DC, 20005, US

(21) Appl. No.: 10/762,485

(22) Filed: Jan. 23, 2004

(51) Int. Cl. H02J 7/00

(52) U.S. Cl. 320/108

(57) ABSTRACT

An integrated induction battery charge apparatus transforms electric energy and magnetic energy according to electromagnetic induction principle to charge an induction charge battery. It integrates the conventional charge batteries to become an induction charge battery so that users may carry only one charge apparatus to charge the induction batteries of different specifications, thereby improve use convenience.

### FIELD OF THE INVENTION

The present invention relates to an induction battery charge apparatus and particularly to an integrated induction battery charge apparatus.

### BACKGROUND OF THE INVENTION

These days, portable electronic devices are very popular, due to their use convenience. However, charging methods still are a troublesome issue remained to be resolved.

Conventional charging methods generally adopt a conductive charging approach. It is accomplished by connecting metal contacts, to direct electric energy into the battery for charging. Such an approach has charging environment restrictions (such as submerged). It also has to couple with dedicated chargers to match various battery specifications (such as 18.5 V, 15 V, 10 V, etc.), and many interface specifications (such as 5-pin legs, 6-pin legs, 7-pin legs, etc.).

When charging is required, a dedicated charging dock or dedicated DC power supply has to be provided. If the batteries of multiple number of portable electronic devices require charging, users have to prepare many types of dedicated chargers. This is very inconvenient.

### SUMMARY OF THE INVENTION

In view of the problems set forth above, the primary object of the invention is to provide an integrated induction battery charge apparatus. It is charged by induction. It can perform charging in environments where conventional conductive chargers can't. And it also can charge batteries of different interface specifications.

In order to achieve the foregoing object, the integrated induction battery charge apparatus according to the invention includes a first induction module, a second induction module, a detection module, an activation module, a rectification module and a filter module. After the charge apparatus has detected the induction battery, it starts the charging process. The second induction module at the battery end detects an AC voltage, which is rectified and filtered, and a DC voltage is generated to charge the battery. Through induction charging without contacts, it can perform a charging process in the environments (such as submerged) where conventional conductive charge methods can't be performed.

The second induction module is at the battery end to enable the induction charge apparatus to charge induction batteries of different specifications. Hence users need to carry only one type of charger. This resolves the problem of preparing dedicated chargers for different specifications of batteries. This is more convenient.

The foregoing, as well as additional objects, features and advantages of the invention will be more readily apparent from the following detailed description, which proceeds with reference to the accompanying drawings.

### BRIEF DESCRIPTION OF THE DRAWINGS

The invention will become more fully understood from the detailed description given herein below illustration only, and thus are not limitative of the present invention, and wherein:

FIG. 1 is a functional block diagram of the invention; and

FIG. 2 is a circuit diagram of the invention.

### DESCRIPTION OF THE PREFERRED EMBODIMENT

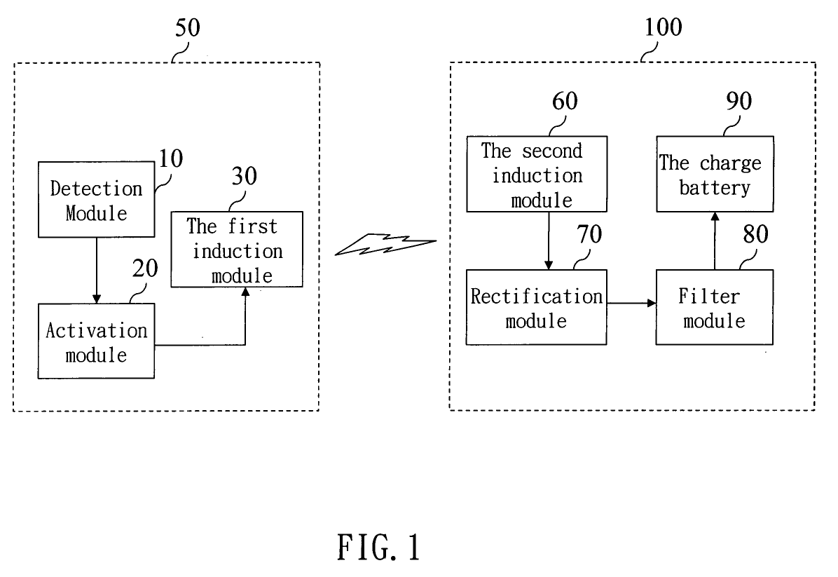

Refer to FIG. 1 for a functional block diagram of the invention. The integrated induction battery charge apparatus according to the invention aims at employing electromagnetic induction principles, to charge chargeable batteries. It includes a detection module 10, an activation module 20, a first induction module 30, a second induction module 60, a rectification module 70, a filter module 80 and a charge battery 90.

The detection module 10 is located at a charging end 50, to send a detection signal to a battery end 100 and receive a response signal, to indicate the presence of the charge battery 90, and generate an activation signal to start the charging process. The module uses the detection approach to control the electromagnetic induction charge process and to prevent the charging end 50 from continuously sending out induction electromagnetic waves when the charging process stops. Further, it uses the detection approach to avoid causing interference to the signal transmission or receiving devices in the surrounding area, and also to avoid causing a harmful effect to the human body. The detection module 10 detects by electromagnetic induction or piezoelectric induction.

The activation module 20 is connected to the detection module 10. After having received the activation signal, a charge power supply is set ON to provide the required electric power for the first induction module 30. The activation module 20 consists of at least one metal-oxide-semiconductor (MOS) transistor. The activation signal triggers and turns on a MOS transistor switch, to provide the required electric power for the first induction module 30.

The first induction module 30 is connected to the activation module 20, and may include an induction coil. When the charge switch is turned on, the first induction module 30 transforms input electric energy to magnetic energy.

The second induction module 60 is located with the charge battery 90 in an integrated manner. It transforms the induction magnetic field generated by the first induction module 30 to induction voltage. The second induction module 60 may include an induction coil with the coil ring number set according to the required charge voltage of various charge batteries so that the induction voltage meeting the requirements of various charge batteries may be generated. Hence, one charge dock may charge multiple number of batteries at various required voltages according to battery specifications.

The rectification module 70 is connected to the second induction module 60 for rectifying the AC voltage generated by the second induction module 60 by induction to become an AC voltage. As the induction voltage on the second induction module 60 at the battery end 100 is an AC voltage, and the charge battery 90 requires a DC voltage for charging, the rectification module 70 is needed to transform the AC voltage to a DC voltage. The rectification module 70 may include a bridge rectifier.

The filter module 80 is connected to the rectification module 70. As the direct current, after rectification, is not stable, the filter module 80 can improve the DC waveform, so that it becomes a desired DC voltage to enhance charging quality and efficiency. The filter module 80 may be a circuit consisting of at least one inductor and one capacitor coupling in parallel.

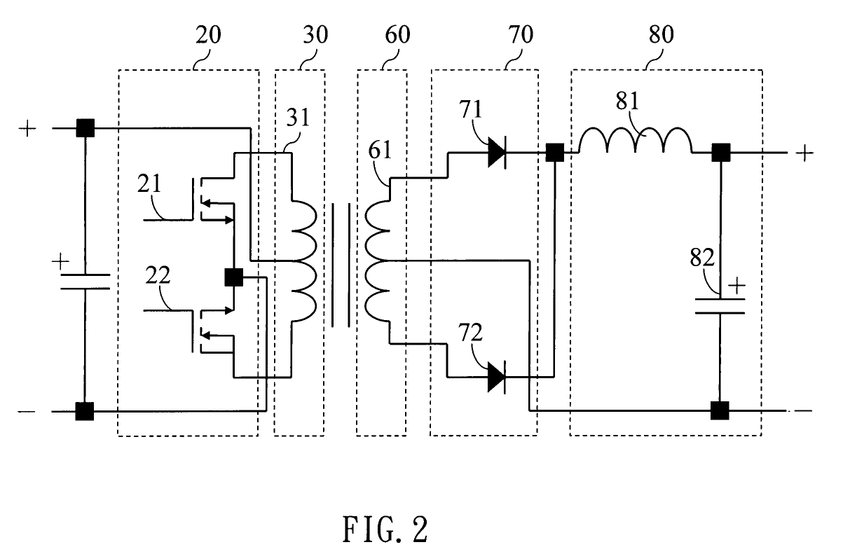

Refer to FIG. 2 for the circuit diagram of the invention. First, the power supply end inputs an AC voltage; the detection module detects and triggers the activation module 20, which consists of MOS transistors 21 and 22. As the AC voltage has different positive and negative half cycles, the MOS transistors 21 and 22 form two different circuits, and through the first induction module 30 generate an alternate induction magnetic field. The first induction module 30 may include an induction coil 31.

Next, the second induction module 60 receives the alternate induction magnetic field, and according to the electromagnetic induction principle, the alternate induction magnetic field is transformed to an induction AC voltage. The second induction module 60 may include an induction coil 61. The level of the induction voltage depends on the number of coil rings of the second induction module 60.

Then the induction AC voltage is rectified by the rectification module 70. The rectification module 70 may consist of diodes 71 and 72. Then is filtered by the filter module 80. The filter module 80 may consist of an inductor 81 and a capacitor 82 coupling in parallel.

When the induction AC voltage is at the positive half cycle, the rectification diode 71 is conductive, and the positive half cycle power supply passes through the circuit of the rectification diode 71. Through the inductor 81 and the capacitor 82, the DC waveform may be improved. When the rectification diode 72 is conductive, and the negative half cycle power supply passes through the circuit of the rectification diode 72, and through the inductor 81 and the capacitor 82, the DC waveform may be improved.

The voltage after rectification is stored in the capacitor 82. By means of discharge principle of the capacitor 82, it charges the charge battery. When the voltage of the charge battery is saturated, the capacitor 82 and the charge battery reach the same potential, then the capacitor 80 stops the charging process. Hence there is no risk of overcharging the charge battery.

By means of the integrated induction battery charge apparatus set forth above, a plurality of batteries of various specifications may be charged through one charge apparatus. The induction charge process also may be implemented with less restriction of the charge environment. Thus it is more convenient.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

1. An integrated induction battery charge apparatus having a charge end to generate an induction magnetic field to charge an induction charge battery, comprising:
a power supply to provide electric energy;
a detection module located on the charge end to detect the charge battery and to generate a start signal when the charge battery is detected;
an activation module connected to the detection module for receiving the start signal and turning on a power supply switch; and
an induction module connected to the activation module for transforming the electric energy provided by the power supply to magnetic energy through electromagnetic induction.

2. The integrated induction battery charge apparatus of claim 1, wherein the induction module includes an induction coil.

3. The integrated induction battery charge apparatus of claim 1, wherein the detection module detects through electromagnetic induction.

4. The integrated induction battery charge apparatus of claim 1, wherein the detection module detects through piezoelectric induction.

5. The integrated induction battery charge apparatus of claim 1, wherein the activation module includes metal oxide semiconductor switches.

6. An integrated induction charge battery, comprising:
a charge battery;
an induction module integrated with the charge battery for transforming magnetic energy transferred from a charge end to electric energy through electromagnetic induction to charge the charge battery; and
a rectification module connected to the induction module for transforming an AC voltage generated by the induction to a DC voltage.

7. The battery of claim 6, wherein the battery further includes a filter module which is connected to the rectification module for improving the waveform of the DC voltage output from the rectification module.

8. The battery of claim 7, wherein the filter module includes at least one inductor and at least one capacitor coupling in parallel.

9. The battery of claim 6, wherein the induction module includes an induction coil.

10. The battery of claim 6, wherein the induction module includes an induction coil which has a desired number of coil rings according to voltage specifications of the battery.

11. The battery of claim 6, wherein the rectification module is a bridge rectifier.

12. The battery of claim 6, wherein the battery is a battery of a portable information process apparatus.

13. The battery of claim 6, wherein the battery is a battery of a mobile communication apparatus.
